(19) United States
(12) Patent Application Publication
(10) Pub. No.: US 2008/0172807 A1
(43) Pub. Date: Jul. 24, 2008

(54) Treatment of hair fibers with a composition comprising reactive silicone compounds, before or after a dyeing method

(76) Inventor: Gaelle Brun, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/003,093

(22) Filed: Dec. 20, 2007

Related U.S. Application Data
(60) Provisional application No. 60/898,750, filed on Feb. 1, 2007.

(30) Foreign Application Priority Data
Dec. 20, 2006 (FR) 0655756

(51) Int. Cl. A61Q 5/10

(52) U.S. Cl. 8/431

(57) ABSTRACT

The present disclosure provides a method of treating human keratin fibers, either before or after dyeing said fibers, which comprises applying to said fibers, either before or after said dyeing step, at least one composition comprising at least one compound X and at least one compound Y, at least one of the compounds X and Y being a silicone compound, wherein, when X and Y are placed in contact with each other they react together via a hydrosilylation reaction, a condensation reaction, or a crosslinking reaction in the presence of a peroxide.

This application claims benefit of U.S. Provisional Application No. 60/898,750, filed Feb. 1, 2007, the contents of which are incorporated herein by reference. This application also claims benefit of priority under 35 U.S.C. § 119 to French Patent Application No. FR 06 55756, filed Dec. 20, 2006, the contents of which are also incorporated herein by reference.

The present disclosure provides a method of treating human keratin fibers, either before or after dyeing said fibers, which comprises applying, either before or after said dyeing step, at least one composition comprising at least one compound X and at least one compound Y, wherein at least one of the compounds X and Y is a silicone compound; wherein when X and Y are placed in contact with each other, these compounds being further able to react, or do react, together by via a hydrosilylation reaction, or a condensation reaction, or a crosslinking reaction in the presence of a peroxide.

Within the art of the dyeing of hair fibers it is known to employ a variety of techniques, starting for example, from direct dyes in the case of non-permanent dyeings, or from dye precursors in the case of permanent dyeings.

Non-permanent dyeing or direct dyeing comprises dyeing the fibers with dyeing compositions containing direct dyes. These dyes may be soluble coloring and colored molecules which have an affinity for the hair. They may be applied to the fibers for a period of time required for the desired dyeing to be obtained, and then may be rinsed off.

The conventional dyes which are used are, for example, nitrobenzene, anthraquinone, nitropyridine, azo, xanthene, acridine, azine and triarylmethane dyes or natural dyes.

It is also known to dye the hair permanently by oxidation dyeing. This dyeing technique comprises applying to the fibers a composition containing dye precursors such as oxidation bases and couplers. Under the action of an oxidizing agent, these precursors can form the at least one colored species by an oxidative condensation reaction within the actual fiber.

The variety of molecules employed as oxidation bases and couplers allows a rich palette of colors to be obtained, and the resulting dyeings are permanent, strong, and resistant to external agents, such as light, weathering, washing, perspiration and friction.

Whatever the mode of dyeing envisaged, though, permanent or semi-permanent, the glints of the dyeing are observed to fade with the successive shampooings to which the hair is subjected, leading to less vivid and less attractive colors. This effect is all the more visible when the color is a so-called hot color, in other words one with shades of red or copper.

Another difficulty of the methods of dyeing keratin fibers lies in the need to obtain dyeings which are as homogeneous as possible. In fact it is well known that keratin fibers, as a function of their degree of sensitization caused by the action of external agents (sun, hair treatments such as perming, and dyeings), exhibit a certain heterogeneity along a single fiber and from one fiber to another. The consequence of this is to vary the affinity of the dye and the fiber and hence to lead to non-homogeneous dyeings.

Thus there is a need in the art to find not only a method of diminishing the phenomenon of color fading, but also a method of enhancing the homogeneity of the dyeing obtained.

Accordingly, the present disclosure provides a method of treating human keratin fibers which comprises applying, either before or after a dyeing step, at least one composition comprising at least one compound X and at least one compound Y, wherein at least one of the compounds, X and Y, is a silicone compound, wherein, when X and Y are placed in contact with each other they react together via a hydrosilylation reaction, or a condensation reaction, or a crosslinking reaction in the presence of a peroxide.

The present disclosure provides a method to sheathe the fibers in a way which persists over several shampooings.

Moreover, it has been found, surprisingly, that the hair can be styled without problem.

The method disclosed herein may be employed immediately before or after a conventional dyeing method.

Other features and benefits of the present disclosure will, however, become more clearly apparent from a reading of the description and examples which follow.

It should be noted that, in the text below, the endpoints encompassing a range of values are included in that range unless specifically indicated otherwise.

As has been indicated above, the composition applied to the fibers comprises at least one compound X and at least one compound Y, wherein at least one is a silicone compound.

### Compounds X and Y

A silicone compound, as disclosed herein, is a compound comprising at least two organosiloxane units. In at least one embodiment the compounds X and the compounds Y are both silicone compounds. The compounds X and Y may be aminated or non-aminated. They may comprise polar groups chosen from the following groups: —COOH, —COO⁻, —COO—, —OH, —NH₂, —NH—, —NR—, —SO₃H, —SO₃⁻, —OCH₂CH₂—, —O—CH₂CH₂CH₂—, —O—CH₂CH(CH₃)—, —NR₃⁺, —SH, —NO₂, I, Cl, Br, —CN, —PO₄³⁻, —CONH—, —CONR—, —CONH₂, —CSNH—, —SO₂—, —SO—, —SO₂NH—, —NHCO—, —NHSO₂—, —NHCOO—, —OCONH—, —NHCSO— and —OCSNH—, wherein R represents an alkyl group.

In another embodiment, at least one of the compounds, X and Y, is a polymer whose main chain is formed predominantly of organosiloxane units.

Some of the silicone compounds mentioned below may have both film-forming properties and adhesive properties, depending, for example, on their proportion of silicone or on whether they are used in a mixture with a specific additive. It is possible, consequently, to modify the film-forming properties or the adhesive properties of such compounds in accordance with the intended use; this is the case, for example, for the reactive elastomeric silicones known as “room temperature vulcanization” silicones.

When placed in contact with each other, the at least one compound X and the at least one compound Y react together at a temperature ranging from ambient temperature to 180° C. According to at least one embodiment the at least one compound X and the at least one compound Y, when placed in contact with each other, react together at ambient temperature (20±5° C.) and atmospheric pressure, for instance in the presence of a catalyst, via a hydrosilylation reaction or a condensation reaction, or a crosslinking reaction in the presence of a peroxide.

Compounds X and Y able to React by Hydrosilylation

In at least one embodiment, the at least one compound X and the at least one compound Y, when placed in contact with each other, react together by hydrosilylation, a reaction which can be depicted in a simplified way as follows:

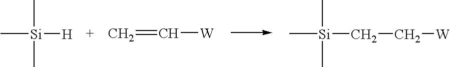

wherein
W represents a carbon or silicone chain containing at least one unsaturated aliphatic group.

In this case the at least one compound X may be chosen from silicone compounds comprising at least two unsaturated aliphatic groups. For example, the at least one compound X may comprise a main silicone chain whose unsaturated aliphatic groups are pendant to the main chain (side group) or are situated at the ends of the main chain of the compound (terminal group). These specific compounds, as disclosed herein, will be referred to as polyorganosiloxanes having unsaturated aliphatic groups.

In at least one embodiment, the at least one compound X is chosen from polyorganosiloxanes comprising at least two unsaturated aliphatic groups, for example, two or three vinyl or allyl groups, each bonded to a silicon atom.

In at least one embodiment, the at least one compound X is chosen from polyorganosiloxanes comprising siloxane units of formula (I):

$${R}_{m} {R}^{′} {SiO}_{\frac{( 3 - m )}{2}} \qquad ( I )$$

in which:
R is chosen from monovalent linear or cyclic hydrocarbon groups, containing 1 to 30 carbon atoms, such as 1 to 20, for instance, 1 to 10 carbon atoms, such as, short-chain alkyl radicals, containing for example 1 to 10 carbon atoms, for example a methyl radical or else a phenyl groups; such as a methyl radical,
m is 1 or 2, and
R′ is chosen from:
   unsaturated aliphatic hydrocarbon groups containing 2 to 10, for instance, 2 to 5 carbon atoms such as, vinyl groups or —R″—CH═CHR′″ wherein R″ is a divalent aliphatic hydrocarbon chain containing 1 to 8 carbon atoms which is bonded to the silicon atom, and R′″ is chosen from hydrogen and C₁-C₄ alkyl radicals, for instance, a hydrogen atom; R′ is chosen from vinyl groups and allyl groups; and
   unsaturated cyclic hydrocarbon groups containing 5 to 8 carbon atoms, such as, for example, a cyclohexenyl group.

In at least one embodiment, R′ is an unsaturated aliphatic hydrocarbon group, such as a vinyl group.

In at least one embodiment, the polyorganosiloxane further comprises units of formula (II):

$${R}_{n} {SiO}_{\frac{( 4 - n )}{2}} \qquad ( II )$$

wherein R is a group as defined above and n is 1, 2 or 3.

According to one embodiment, the at least one compound X may be a silicone resin containing at least two ethylenic unsaturations, wherein said resin is capable of reacting with the at least one compound Y by hydrosilylation. Possible examples include the resins of type MQ or MT which carry unsaturated reactive end groups —CH═CH₂.

These resins may be crosslinked organosiloxane polymers.

The nomenclature of silicone resins is known by the name of “MDTQ”, wherein the resin being described is a function of the different monomeric siloxane units it comprises, wherein each of the letters MDTQ characterize one type of unit.

The letter M represents a monofunctional unit of formula (CH₃)₃SiO_{1/2}, wherein the silicon atom is joined to a single oxygen atom in the polymer comprising this unit.

The letter D signifies a difunctional unit (CH₃)₂SiO_{2/2} in which the silicon atom is joined to two oxygen atoms.

The letter T represents a trifunctional unit of formula (CH₃)SiO_{3/2}.

In the units M, D and T, as defined above, at least one of the methyl groups may be substituted by a group, R, other than the methyl group, chosen from C₂ to C₁₀ hydrocarbon radicals (for example, alkyl), a phenyl group, and a hydroxyl group.

Finally, the letter Q signifies a tetrafunctional unit SiO_{4/2} in which the silicon atom is bonded to four hydrogen atoms which are themselves bonded to the remainder of the polymer. Examples of such resins include the MT silicone resins such as the poly(phenylvinylsilsesquioxanes) like those sold under the name SST-3PV1 by Gelest.

The compounds X contain, for example, from 0.01% to 1% by weight of unsaturated aliphatic groups.

In at least one embodiment, the at least one compound X is chosen from polyorganopolysiloxanes, for example, those comprising at least the siloxane units (I) and optionally (II) described above.

In another embodiment, the at least one compound Y comprises at least two free Si—H groups (hydrogenosilane groups).

In at least one embodiment, the at least one compound Y may be chosen from organosiloxanes comprising at least one alkylhydrogenosiloxane unit of formula (III):

$${R}_{p} {HSiO}_{\frac{( 3 - p )}{2}} \qquad ( III )$$

wherein:

R is chosen from monovalent linear or cyclic C₁ to C₃₀ hydrocarbon groups, for example, C₁ to C₂₀ hydrocarbon groups, and for instance, C₁ to C₁₀ hydrocarbon groups, such as, C₁ to C₁₀ short-chain alkyl radicals, such as methyl radicals, and phenyl groups, and p is 1 or 2. In at least one embodiment, R is a hydrocarbon group, such as methyl.

These organosiloxane compounds Y having alkylhydrogenosiloxane units may further comprise units of formula (II):

$${R}_{n} {SiO}_{\frac{( 4 - n )}{2}} \qquad ( II )$$

as defined above.

The at least one compound Y may be a silicone resin comprising at least one unit chosen from the M, D, T and Q units as defined above and comprising at least one Si—H group, such as the poly(methylhydridosilsesquioxanes) sold under the name SST-3 MH1.1 by Gelest.

These organosiloxane compounds Y contain, for example, from 0.5% to 2.5% by weight of Si—H groups.

In at least one embodiment, R represents a methyl group in the formulae (I), (II) and (III) above.

In at least one embodiment, these organosiloxanes Y comprise terminal groups of formula (CH₃)₃SiO_{1/2}.

In another embodiment, the organosiloxanes Y comprise at least two alkylhydrogenosiloxane units of formula (H₃C)(H)SiO and optionally comprise (H₃C)₂SiO units.

Organosiloxane compounds Y of this kind containing hydrogenosilane groups are described for example in document EP 0465744.

In one embodiment, the at least one compound X is chosen from organic oligomers and polymers (organic compounds, as described herein, are those whose main chain is not a silicone chain, for example, compounds containing no silicon atoms) or from hybrid organic/silicone polymers and oligomers, wherein the oligomers or polymers carry at least two reactive unsaturated aliphatic groups, and the at least one compound Y is chosen from the aforementioned hydrogenosiloxanes.

The at least one compound X, which is organic in nature, may then be chosen from vinyl and (meth)acrylic oligomers and polymers, polyesters, polyurethanes, polyureas, polyethers, perfluoropolyethers, polyolefins such as polybutene and polyisobutylene, and dendrimers and hyperbranched organic polymers.

In at least one embodiment, the organic polymer or the organic part of the hybrid polymer may be chosen from the following polymers:
a) Ethylenically unsaturated polyesters:
   this is a group of polymers of polyester type having at least two ethylenic double bonds distributed anywhere in the main chain of the polymer. These unsaturated polyesters may be obtained by polycondensation of a mixture:
      of linear or branched aliphatic or cycloaliphatic carboxylic diacids comprising, in at least one embodiment, 3 to 50 carbon atoms, for example, 3 to 20 carbon atoms, for instance, 3 to 10 carbon atoms, such as adipic acid or sebacic acid, aromatic carboxylic diacids comprising, in at least one embodiment, 8 to 50 carbon atoms, for example, 8 to 20 carbon atoms, for instance, 8 to 14 carbon atoms, such as phthalic acids, such as terephthalic acid, and/or carboxylic diacids obtained from dimers of ethylenically unsaturated fatty acids, such as the dimers of oleic or linoleic acids that are described in patent application EP-A-959 066 (paragraph [0021]) and are sold under the names Pripol® by Unichema or Empol® by Henkel, all of these diacids necessarily being devoid of polymerizable ethylenic double bonds,
      of linear or branched aliphatic or cycloaliphatic diols comprising, in at least one embodiment, 2 to 50 carbon atoms, for example, 2 to 20 carbon atoms, for instance, 2 to 10 carbon atoms, such as ethylene glycol, diethylene glycol, propylene glycol, 1,4-butanediol or cyclohexanedimethanol, aromatic diols comprising 6 to 50 carbon atoms, for example, 6 to 20 carbon atoms, for instance, 6 to 15 carbon atoms, such as bisphenol A and bisphenol B, and/or diol dimers obtained from the reduction of dimers of fatty acids as defined above, and
      of at least one carboxylic diacid or its anhydrides containing at least one polymerizable ethylenic double bond and comprising 3 to 50 carbon atoms, for example, 3 to 20 carbon atoms, for instance, 3 to 10 carbon atoms, such as maleic acid, fumaric acid or itaconic acid.
b) Polyesters having side and/or terminal (meth)acrylate groups:
   this is a group of polymers of polyester type which are obtained by polycondensation of a mixture:
      of linear or branched aliphatic or cycloaliphatic carboxylic diacids containing, in at least one embodiment, 3 to 50 carbon atoms, for example, 3 to 20 carbon atoms, for instance 3 to 10 carbon atoms, such as adipic acid or sebacic acid, aromatic carboxylic diacids comprising 8 to 50 carbon atoms, for example, 8 to 20 carbon atoms, for instance, 8 to 14 carbon atoms, such as phthalic acids, for example, terephthalic acid, and carboxylic diacids obtained from dimers of ethylenically unsaturated fatty acids, such as the dimers of oleic or linoleic acids that are described in patent application EP-A-959 066 (paragraph [0021]) and are sold under the names Pripol® by Unichema or Empol® by Henkel, all of these diacids necessarily being devoid of polymerizable ethylenic double bonds,
      of linear or branched aliphatic or cycloaliphatic diols containing, in at least one embodiment, 2 to 50 carbon atoms, for example, 2 to 20 carbon atoms, for instance, 2 to 10 carbon atoms, such as ethylene glycol, diethylene glycol, propylene glycol, 1,4-butanediol or cyclohexanedimethanol, aromatic diols comprising 6 to 50 carbon atoms, for example, 6 to 20 carbon atoms, for instance, 6 to 15 carbon atoms, such as bisphenol A and bisphenol B, and
      of at least one ester of (meth)acrylic acid and a diol or polyol comprising 2 to 20 carbon atoms, for example, 2 to 6 carbon atoms, such as 2-hydroxyethyl (meth)acrylate, 2-hydroxypropyl (meth)acrylate and glycerol methacrylate.

These polyesters are different from those described above in section a) in that the ethylenic double bonds are situated not in the main chain but on side groups or at the end of the chains. These ethylenic double bonds are those of the (meth)acrylate groups present in the polymer.

Polyesters of this kind are sold, for example, by UCB under the names Ebecryl® (Ebecryl® 450: molar mass 1600, on average 6 acrylate functions per molecule, Ebecryl® 652: molar mass 1500, on average 6 acrylate functions per molecule, Ebecryl® 800: molar mass 780, on average 4 acrylate functions per molecule, Ebecryl® 810: molar mass 1000, on average 4 acrylate functions per molecule, Ebecryl® 50 000: molar mass 1500, on average 6 acrylate functions per molecule).
c) Polyurethanes and/or polyureas having (meth)acrylate groups, obtained by polycondensation:
   of aliphatic, cycloaliphatic and/or aromatic diisocyanates, triisocyanates and/or polyisocyanates, having, for example, 4 to 50, for instance, 4 to 30, carbon atoms, such as hexamethylene diisocyanate, isophorone diisocyanate, toluene diisocyanate, diphenylmethane diisocyanate or the isocyanurates of formula:

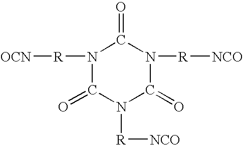

resulting from the trimerization of 3 molecules of diisocyanates OCN—R—CNO, wherein R is a linear, branched or cyclic hydrocarbon radical containing 2 to 30 carbon atoms;
of polyols, for example, of diols, which are devoid of polymerizable ethylenic unsaturations, such as 1,4-butanediol, ethylene glycol or trimethylolpropane, and/or of polyamines, for example, diamines, which are aliphatic, cycloaliphatic and/or aromatic and have for example, 3 to 50 carbon atoms, such as ethylenediamine or hexamethylenediamine, and
of at least one ester of (meth)acrylic acid and a diol or polyol having 2 to 20 carbon atoms, for instance, 2 to 6 carbon atoms, such as 2-hydroxyethyl (meth)acrylate, 2-hydroxypropyl (meth)acrylate and glycerol methacrylate.

Polyurethanes/polyureas of these kinds containing acrylate groups are sold, for example, under the name SR 368 (tris(2-hydroxyethyl) isocyanurate triacrylate) or Craynor® 435 by Cray Valley, or under the name Ebecryl® by UCB (Ebecryl® 210: molar mass 1500, 2 acrylate functions per molecule, Ebecryl® 230: molar mass 5000, 2 acrylate functions per molecule, Ebecryl® 270: molar mass 1500, 2 acrylate functions per molecule, Ebecryl® 8402: molar mass 1000, 2 acrylate functions per molecule, Ebecryl® 8804: molar mass 1300, 2 acrylate functions per molecule, Ebecryl® 220: molar mass 1000, 6 acrylate functions per molecule, Ebecryl® 2220: molar mass 1200, 6 acrylate functions per molecule, Ebecryl® 1290: molar mass 1000, 6 acrylate functions per molecule, Ebecryl® 800: molar mass 800, 6 acrylate functions per molecule).

Mention may also be made of the water-soluble aliphatic polyurethane diacrylates sold under the names Ebecryl® 2000, Ebecryl® 2001 and Ebecryl® 2002, and of the polyurethane diacrylates in aqueous dispersion that are sold under the trade names IRR® 390, IRR® 400, IRR® 422 and IRR® 424 by UCB.
d) Polyethers having (meth)acrylate groups which are obtained by esterification, with (meth)acrylic acid, of terminal hydroxyl groups of homopolymers or copolymers of C₁₋₄-alkylene glycols, such as polyethylene glycol, polypropylene glycol, the copolymers of ethylene oxide and propylene oxide having, for example, a weight-average molecular mass of less than 10,000, and polyethoxylated or polypropoxylated trimethylolpropane. Polyoxyethylene di(meth)acrylates of appropriate molar mass are sold for example under the names SR 259, SR 344, SR 610, SR 210, SR 603 and SR 252 by Cray Valley or under the name Ebecryl® 11 by UCB. Polyethoxylated trimethylolpropane triacrylates are sold for example under the names SR 454, SR 498, SR 502, SR 9035 and SR 415 by Cray Valley or under the name Ebecryl® 160 by UCB. Polypropoxylated trimethylolpropane triacrylates are sold for example under the names SR 492 and SR 501 by Cray Valley.
e) Epoxy acrylates obtained by reacting
   at least one diepoxide chosen for example from:
      (i) bisphenol A diglycidyl ether,
      (ii) a diepoxy resin resulting from the reaction of bisphenol A diglycidyl ether and epichlorohydrin,
      (iii) an epoxy ester resin having α,ω-diepoxy ends, resulting from the condensation of a carboxylic diacid having 3 to 50 carbon atoms with a stoichiometric excess of (i) and/or (ii),
      (iv) an epoxy ether resin having α,ω-diepoxy ends, resulting from the condensation of a diol having 3 to 50 carbon atoms with a stoichiometric excess of (i) and/or (ii),
      (v) natural or synthetic oils carrying at least 2 epoxide groups, such as epoxidized soya oil, epoxidized linseed oil and epoxidized vernonia oil,
      (vi) a phenol-formaldehyde polycondensate (Novolac® resin) whose ends and/or side groups have been epoxidized,
   and
   at least one carboxylic acid or polycarboxylic acid containing at least one ethylenic double bond positioned α,β to the carboxyl group, such as (meth)acrylic acid or crotonic acid, or the esters of (meth)acrylic acid and a diol or polyol having 2 to 20 carbon atoms, for instance 2 to 6 carbon atoms, such as 2-hydroxyethyl (meth)acrylate.

Polymers of this kind are sold for example under the names SR 349, SR 601, CD 541, SR 602, SR 9036, SR 348, CD 540, SR 480 and CD 9038 by Cray Valley, under the names Ebecryl® 600 and Ebecryl® 609, Ebecryl® 150, Ebecryl® 860 and Ebecryl® 3702 by UCB, and under the names Photomer® 3005 and Photomer® 3082 by Henkel.
f) Poly-C₁₋₅₀ alkyl (meth)acrylates, wherein the alkyl is linear, branched or cyclic, and contains at least two functional groups having an ethylenic double bond, which are carried by the terminal and/or side hydrocarbon chains. Copolymers of this kind are sold, for example, under the names IRR® 375, OTA® 480 and Ebecryl® 2047 by UCB.
g) Polyolefins such as polybutene and polyisobutylene.
h) Perfluoropolyethers comprising acrylate groups which are obtained by esterification, for example with (meth)acrylic acid, of perfluoropolyethers which carry terminal and/or side hydroxyl groups. α,ω-Diol perfluoropolyethers of this kind are described for instance, in EP-A-1057849 and are sold by Ausimont under the name Fomblin® Z Diol.
i) Dendrimers and hyperbranched polymers which carry terminal (meth)acrylate or (meth)acrylamide groups obtained respectively by esterification or amidification of dendrimers and hyperbranched polymers having terminal hydroxyl or amino functional groups with (meth)acrylic acid.

Dendrimers (from the Greek dendron=tree) are “arborescent”, in other words highly branched, polymer molecules invented by D. A. Tomalia and his team at the beginning of the 1990s (Donald A. Tomalia et al., Angewandte Chemie, Int. Engl. Ed., vol. 29, no. 2, pages 138-175). They are structures constructed around a generally polyfunctional central unit. Arranged in chains around this central unit, in accordance with a well-defined structure, are branched chain-extension units, hence giving rise to monodisperse symmetrical macromolecules which have a well-defined chemical and stereochemical structure. Polyamidoamine dendrimers are sold for example under the name Starburst® by Dendritech.

Hyperbranched polymers are polycondensates, generally of polyester, polyamide or polyethyleneamine type, which are obtained from polyfunctional monomers, which have an arborescent structure similar to that of the dendrimers but is much less regular (see, for example, WO-A-93/17060 and WO 96/12754).

Under the name Boltorn®, the company Perstorp sells hyperbranched polyesters. Hyperbranched polyethyleneamines are found under the name Comburst® from the company Dendritech. Hyperbranched poly(esteramides) having hydroxyl ends are sold by the company DSM under the name Hybrane®.

These dendrimers and hyperbranched polymers, esterified or amidified by acrylic and/or methacrylic acid, differ from the polymers described in sections a) to h) above in the very large number of ethylenic double bonds present. This high functionality, most often greater than 5, allows them to act as a “crosslinking node”, in other words as a site of multiple crosslinking.

It is therefore possible to use these dendritic and hyperbranched polymers in combination with at least one of the polymers and/or oligomers a) to h) above.

### Additional Reactive Compounds

In at least one embodiment, the compositions comprising at least one of the compounds X and Y may further comprise at least one additional reactive compound such as:
organic or inorganic particles comprising on their surface at least two unsaturated aliphatic groups, examples including silicas surface-treated with, for example, silicone compounds having vinyl groups, such as, for example, cyclotetramethyltetravinylsiloxane-treated silica;
silazane compounds such as hexamethyldisilazane.

### Catalyst

In one embodiment, the hydrosilylation reaction takes place in the presence of a catalyst which may be present in one or other of the compositions comprising the at least one compound X and the at least one compound Y or in a separate composition, the catalyst being based on, for example, platinum or on tin.

Examples include catalysts based on platinum deposited on a silica gel support or on a charcoal powder (carbon) support, platinum chloride, platinum salts and chloroplatinic acids.

In one embodiment of the present disclosure, chloroplatinic acids in hexahydrate or anhydrous form, which are readily dispersible in organosilicone media, are used.

Non-limiting mention may also be made of platinum complexes such as those based on chloroplatinic acid hexahydrate and divinyltetramethyldisiloxane.

The catalyst may be present in at least one of the composition disclosed herein in an amount ranging from 0.0001% to 20% by weight relative to the total weight of the composition comprising it.

In at least one of the compositions disclosed herein, it is also possible to introduce polymerization inhibitors or retardants, for example, catalyst inhibitors, for the purpose of increasing the stability of the composition over time or of retarding the polymerization. Without limitation mention may be made of cyclic polymethylvinylsiloxanes, such as tetravinyltetramethylcyclotetrasiloxane, and acetylenic alcohols, for example, volatile acetylenic alcohols, such as methylisobutynol.

The presence of ionic salts, such as sodium acetate, in one and/or the other of the first and second compositions may influence the rate of polymerization of the compounds.

An example of a combination of compounds X and Y which react by hydrosilylation includes the following examples provided by Dow Corning: DC7-9800 Soft Skin Adhesive Parts A & B, and also the following mixtures A and B prepared by Dow Corning:

### Mixture A:

| | | Amounts | |
|---|---|---|---|
| Ingredient (INCI name) | CAS No. | (% by wt.) | Function |
| Dimethyl Siloxane, | 68083-19-2 | 55-95 | polymer |
| Dimethylvinylsiloxy- | | | |
| terminated | | | |
| Silica Silylate | 68909-20-6 | 10-40 | filler |
| 1,3-Diethenyl-1,1,3,3- | 68478-92-2 | trace | catalyst |
| Tetramethyldisiloxane | | | |
| complexes | | | |
| Tetramethyldivinyldisiloxane | 2627-95-4 | 0.1-1 | polymer |

### Mixture B:

| | | Amounts | |
|---|---|---|---|
| Ingredient (INCI name) | CAS No. | (% by wt.) | Function |
| Dimethyl Siloxane, | 68083-19-2 | 55-95 | polymer |
| Dimethylvinylsiloxy- | | | |
| terminated | | | |
| Silica Silylate | 68909-20-6 | 10-40 | filler |
| Dimethyl, Methyl-hydrogen | 68037-59-2 | 1-10 | polymer |
| Siloxane, trimethylsiloxy- | | | |
| terminated | | | |

In at least one embodiment, the at least one compound X and at least one compound Y are chosen from silicone compounds able to react by hydrosilylation. For example, in at least one embodiment, the at least one compound X is chosen from polyorganosiloxanes containing units of formula (I) described above, and the at least one compound Y is chosen from organosiloxanes containing alkylhydrogenosiloxane units of formula (III) described above. In another embodiment the at least one compound X is a polydimethylsiloxane having terminal vinyl groups, and the at least one compound Y is methylhydrogenosiloxane.

Compounds X and Y able to React by Condensation

In one embodiment when the at least one compounds X and Y are placed in contact with each other they react together by condensation, either in the presence of water (hydrolysis), by reaction of two compounds which carry alkoxysilane groups, or by so-called direct condensation, by reaction of a compound which carries at least one alkoxysilane group and a compound which carries at least one silanol group, or by reaction of two compounds which carry at least one silanol group.

When the condensation takes place in the presence of water, the water can be provided by an external source, for example, by wetting of the hair beforehand (by means of an atomizer, for example).

In this mode of condensation reaction, the at least one compounds X and Y, which are identical or different, may be chosen from silicone compounds whose main chain comprises at least two alkoxysilane groups and/or at least two silanol groups (Si—OH), which are side groups and/or chain-end groups.

In one embodiment, the at least one compounds X and Y are both chosen from polyorganosiloxanes comprising at least two alkoxysilane groups. An alkoxysilane group is a group comprising at least one moiety —Si—OR, wherein R is a C₁ to C₆ alkyl group.

In another embodiment, the at least one compounds X and Y are chosen from polyorganosiloxanes comprising terminal alkoxysilane groups, for example, those which comprise at least two terminal alkoxysilane groups, such as terminal trialkoxysilane groups.

In at least one embodiment, the at least one compounds X and Y comprise units of formula (IV):

R⁹ₛSiO_{4-x/2}, (IV)

in which R⁹ independently represents a radical chosen from C₁ to C₆ alkyl groups, phenyl and fluoroalkyl groups, and s is 0, 1, 2 or 3. In at least one embodiment, R⁹ independently represents a C₁ to C₆ alkyl group. As the alkyl group, mention may be made of, for example, methyl, propyl, butyl, hexyl and mixtures thereof, for example, methyl or ethyl. As the fluoroalkyl group, mention may be made of 3,3,3-trifluoropropyl.

In another embodiment, the at least one compounds X and Y, which are identical or different, are polyorganosiloxanes comprising units of formula (V):

R⁹₂SiO₂)_{f}— (V)

in which R⁹ is as described above, R⁹ can be, for example, a methyl radical, and f is for example, such that the polymer advantageously has a viscosity at 25° C. of from 0.5 to 3000 Pa.s, for instance, of from 5 to 150 Pa.s, and/or f is a number of from 2 to 5000, for example, from 3 to 3000, for instance, from 5 to 1000.

In at least one embodiment, the polyorganosiloxane compounds X and Y comprise at least two terminal trialkoxysilane groups per polymer molecule, wherein said groups have the formula (VI)

-ZSiR¹ₓ(OR)₃₋ₓ, (VI)

wherein
R is independently chosen from methyl, ethyl, n-propyl, isopropyl, n-butyl, sec-butyl or isobutyl group, such as methyl and ethyl groups,
R¹ is chosen from methyl and ethyl groups,
x is 0 or 1, for instance, 0 and
Z is chosen from: divalent hydrocarbon groups containing no ethylenic unsaturation and containing 1 to 18 carbon atoms, for example, 2 to 18 carbon atoms (alkylene groups), and the combinations of divalent hydrocarbon radicals and of siloxane segments of formula (IX):

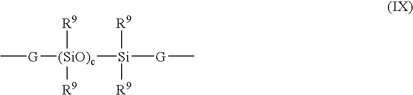

Wherein R⁹ is as described above, G is a divalent hydrocarbon radical containing no ethylenic unsaturation and containing 1 to 18 carbon atoms, for example, 2 to 18 carbon atoms, and c is an integer of from 1 to 6.

Z and G may for example, be chosen from alkylene groups such as methylene, ethylene, propylene, butylene, pentylene and hexylene, and arylene groups such as phenylene.

In at least one embodiment, Z is an alkylene group, for example, an ethylene group.

These polymers may have on average at least 1.2 trialkoxysilane end groups or terminal trialkoxysilane chains per molecule, for example, on average at least 1.5 trialkoxysilane end groups per molecule. These polymers may have at least 1.2 trialkoxysilane end groups per molecule, and some may comprise other types of end groups, such as end groups of formula CH₂═CH—SiR⁹₂— or of formula R⁶₃—Si—, in which R⁹ is as defined above and each group R⁶ is chosen independently from the groups R⁹ or vinyl. Examples of such end groups include trimethoxysilane, triethoxysilane, vinyldimethoxysilane and vinylmethyloxyphenylsilane groups.

Polymers of this kind are described for example, in U.S. Pat. Nos. 3,175,993, 4,772,675, 4,871,827, 4,888,380, 4,898,910, 4,906,719 and 4,962,174, whose content is incorporated by reference into the present patent application.

Among possible compounds X and/or Y it is possible, for example to mention the polymer of formula (VII)

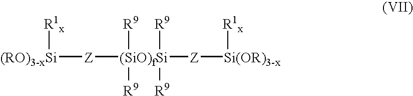

in which R, R¹, R⁹, Z, x and f are as described above.

The at least one compounds X and/or Y may further comprise a mixture of polymers of formula (VII) above with polymers of formula (VIII):

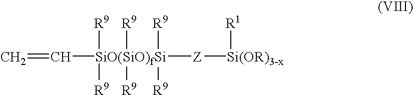

in which R, R¹, R⁹, Z, x and f are as described above.

When the polyorganosiloxane compound X and/or Y comprising at least one alkoxysilane group comprises such a mixture, the different polyorganosiloxanes are present in amounts such that the terminal organosilyl chains represent less than 40%, such as, less than 25%, by number of the terminal chains.

In at least one embodiment, the polyorganosiloxane compounds X and/or Y are those of formula (VII) that were described above. Compounds X and/or Y of this kind are described for example in document WO 01/96450.

As indicated above, the at least one compounds X and Y may be identical or different.

According to one embodiment, one of the two reactive compounds, X or Y, is of silicone type and the other is of organic type. For example, the at least one compound X is chosen from organic oligomers and polymers and hybrid organic/silicone oligomers and polymers, wherein said polymers and oligomers comprise at least two alkoxysilane groups, and Y is chosen from silicone compounds such as the polyorganosiloxanes described above. For example, in one embodiment, the organic oligomers and polymers are chosen from vinyl and (meth)acrylic oligomers and polymers, polyesters, polyamides, polyurethanes, polyureas, polyethers, polyolefins, perfluoropolyethers, organic dendrimers and hyperbranched polymers.

The organic polymers of vinyl or (meth)acrylic kind which carry alkoxysilane side groups may be obtained, for example, by copolymerizing at least one vinyl or (meth)acrylic organic monomer with a (meth)acryloyloxypropyltrimethoxysilane, a vinyltrimethoxysilane, a vinyltriethoxysilane, an allyltrimethoxysilane, etc.

Non-limiting mention may be made for example of the (meth)acrylic polymers described in the document of Kusabe. M, Pitture e Vernici—European Coating; 12-B, pages 43-49, 2005, for example, the polyacrylates having alkoxysilane groups that are called MAX, from Kaneka, or those described in the publication of Probster, M, Adhesion-Kleben & Dichten, 2004, 481 (1-2), pages 12-14.

The organic polymers which result from a polycondensation or from a polyaddition, such as polyesters, polyamides, polyurethanes and/or polyureas, and polyethers, and which carry alkoxysilane side and/or end groups, may result, for example, from the reaction of an oligomeric prepolymer as described above with one of the following silane coreactants which carry at least one alkoxysilane group: aminopropyltri-methoxysilane, aminopropyltriethoxysilane, aminoethylaminopropyltrimethoxysilane, glycidyloxypropyltrimethoxysilane, glycidyloxypropyltriethoxysilane, epoxy-cyclohexylethyltrimethoxysilane, mercaptopropyltrimethoxysilane,

Non-limiting examples of polyethers and of polyisobutylenes having alkoxysilane groups are described in the publication of Kusabe, M., Pitture e Vernici—European Coating; 12-B, pages 43-49, 2005. Possible examples of polyurethanes having alkoxysilane end groups include those described in the document of Probster, M., Adhesion-Kleben & Dichten, 2004, 481 (1-2), pages 12-14 and those described in the document of Landon, S., Pitture e Vernici vol. 73, No. 11, pages 18-24, 1997 and those described in the document of Huang, Mowo, Pitture e Vernici vol. 5, 2000, pages 61-67; mention may also be made of the polyurethanes having alkoxysilane groups from OSI-WITCO-GE.

Among the polyorganosiloxane compounds X and/or Y that may be used, non-limiting mention may be made of the resins of type MQ or MT which themselves carry alkoxysilane and/or silanol ends, such as, for example, the poly(isobutylsilsesquioxane) resins functionalized with silanol groups that are provided under the name SST-S7C41 (3 Si—OH groups) by Gelest.

### Additional Reactive Compounds

At least one of the compositions disclosed herein may further comprise an additional reactive compound comprising at least two alkoxysilane or silanol groups.

Examples include at least one organic or inorganic particle comprising on their surface alkoxysilane and/or silanol groups, for example fillers surface-treated with such groups.

### Catalyst

The condensation reaction may take place in the presence of at least one metal-based catalyst, which may be present in at least one of the compositions comprising X and/or Y or in a separate composition. A catalyst useful in this type of reaction is for example, a catalyst based on titanium.

Non-limiting mention may be made, for example, of the tetraalkoxytitanium-based catalysts of formula

Ti(OR²)_{y}(OR³)_{4-y},

in which R² is chosen from tertiary alkyl radicals such as tert-butyl, tert-amyl and 2,4-dimethyl-3-pentyl; R³ represents a C₁-C₆ alkyl radical, such as methyl, ethyl, n-propyl, isopropyl, n-butyl, sec-butyl or hexyl; and y is a number of from 3 to 4, for example, from 3.4 to 4.

The catalyst may be present in at least one of the compositions disclosed herein, in an amount of from 0.0001% to 20% by weight relative to the total weight of the composition containing it.

### Diluent

Compositions disclosed herein comprising X and/or Y may further comprise at least one volatile silicone oil (or diluent) which may lower the viscosity of the composition.

The at least one oil may be chosen from short-chain linear silicones such as hexamethyldisiloxane and octamethyltrisiloxane and from cyclic silicones such as octa-methylcyclotetrasiloxane and decamethylcyclopentasiloxane.

The at least one silicone oilcan be present in an amount ranging from 5% to 95%, for example, from 10% to 80%, by weight relative to the weight of each composition.

As an example of a combination of compounds X and Y which carry alkoxysilane groups and react by condensation, non-limiting mention may be made of the combination of the following mixtures A′ and B′, prepared by Dow Corning:

### Mixture A′:

| | | Amounts | |
|---|---|---|---|
| Ingredient (INCI name) | CAS No. | (% by wt.) | Function |
| Bis-Trimethoxysiloxyethyl | PMN87176 | 25-45 | polymer |
| Tetramethyldisiloxyethyl | | | |
| Dimethicone (1) | | | |
| Silica Silylate | 68909-20-6 | 5-20 | filler |
| Disiloxane | 107-46-0 | 30-70 | solvent |

### Mixture B′:

| | | Amounts | |
|---|---|---|---|
| Ingredient (INCI name) | CAS No. | (% by wt.) | Function |
| Disiloxane | 107-46-0 | 80-99 | solvent |
| Tetra T Butyl Titanate | — | 1-20 | catalyst |

It should also be noted that the identical compounds X and Y were brought together in the mixture A′.

### Crosslinking in the Presence of Peroxide

In at least one embodiment, the at least one compound X and the at least one compound Y, when placed in contact with each other, react together via crosslinking in the presence of a peroxide. This reaction can take place, for example, by heating at a temperature greater than or equal to 50° C., such as, greater than or equal to 80° C., and of up to 120° C.

In at least one embodiment, the at least one compounds X and Y, which may be identical or different, comprise at least two —CH₃ side groups and/or at least two side chains which carry a —CH₃ group.

In at least one embodiment, the at least one compounds X and Y are silicone compounds and may be chosen, for example, from non-volatile linear polydimethylsiloxanes of high molecular weight, having a degree of polymerization of more than 6, which have at least two —CH₃ side groups joined to the silicon atom and/or at least two side chains which carry a —CH₃ group. Examples include the polymers described in the “Reactive Silicones” catalogue of the company Gelest Inc., 2004 edition, page 6, for example, the vinylmethylsiloxane-dimethylsiloxane copolymers (also called rubbers) of molecular weights of from 500,000 to 900,000 and for instance, those of a viscosity greater than 2,000,000 cSt.

Peroxides disclosed herein include for example, benzoyl peroxide, 2,4-dichlorobenzoyl peroxide and mixtures thereof.

In one embodiment of the present disclosure, the hydrosilylation reaction or the condensation reaction or else the crosslinking reaction in the presence of a peroxide between the at least one compounds X and Y is accelerated by provision of heat, with the temperature of the system being raised, for example, to a temperature ranging from 25° C. to 180° C. The system will react for example, on the skin.

Generally speaking, irrespective of the type of reaction by which the at least one compounds X and Y react together, the molar percentage of X relative to the entirety of the compounds X and Y, i.e. the ratio X/(X+Y)×100, may range from 5% to 95%, for example, from 10% to 90%, for instance, from 20% to 80%.

Similarly, the molar percentage of Y relative to the entirety of the compounds X and Y, i.e. the ratio Y/(X+Y)×100, may range from 5% to 95%, for example, from 10% to 90%, for instance, from 20% to 80%.

The at least one compound X may have a weight-average molecular mass (Mw) ranging from 150 to 1,000,000, for example, from 200 to 800,000, for instance, from 200 to 250,000.

The compound Y may have a weight-average molecular mass (Mw) ranging from 200 to 1,000,000, for example from 300 to 800,000, for instance, from 500 to 250,000.

The at least one compound X may be present in an amount ranging from 0.5% to 95% by weight relative to the total weight of the composition, for example, from 1% to 90% by weight, such as from 5% to 80% by weight.

The compound Y may be present in an amount ranging from 0.05% to 95% by weight relative to the total weight of the composition, for example, from 0.1% to 90% by weight, such as from 0.2% to 80% by weight.

The ratio between the at least one compounds X and Y may be changed so as to modify the rate of reaction and hence the rate at which the film is formed, or else so as to adapt the properties of the resulting film (for example its adhesive properties) in accordance with the desired application.

When X and Y are not the same, the at least one compounds X and Y may be present, for example, in a molar X/Y ratio ranging from 0.05 to 20, such as from 0.1 to 10.

### Texturizers/Fillers

The composition applied to the hair fibers may further comprise at least one texturizer/filler.

Texturizers are mineral or synthetic particles which may be lamellar or non-lamellar and are insoluble in water.

These texturizers may for example be colloidal calcium carbonate, which may be untreated or treated with stearic acid or stearate; silica, such as fumed silicas, precipitated silicas and hydrophobically treated silicas; or ground quartz, or alumina, aluminium hydroxide or diatomaceous earth.

Non-limiting mention may also be made of talc, mica, kaolin, polyamide (Nylon®) powders (Orgasol from Atochem), polyethylene powders, tetrafluoroethylene polymer powders (Teflon®), starch, polymeric microspheres such as those of polyvinylidene chloride/acrylonitrile, for instance Expancel (Nobel Industries) or copolymers of acrylic acid (Polytrap® from Dow Corning).

In one embodiment of the present disclosure, the at least one texturizer is chosen from synthetic silicas whose surface is modified with silicone compounds in order to make them superficially hydrophobic. These texturizers differ from one another in their surface properties, in the silicone compounds used to treat the silica, and in the way in which the surface treatment is carried out.

Texturizers of this kind may allow for the modification of the viscosity of the formulation obtained from the at least one compounds X and/or Y and/or the properties of the material obtained.

In another embodiment of the present disclosure, the at least one texturizer is chosen from silica, calcium carbonate and resin-based texturizers.

Examples include the treated silicas Cab-O—Sil® TS-530, Aerosil® R8200 and Wacker HDX H2000.

The at least one texturizer may be present in an amount ranging from 0% to 48% by weight, relative to the total weight of the composition, such as, from 0.01% to 30% by weight, for instance, from 0.02% to 20% by weight.

### Adjuvants

The composition may also include at least one adjuvant chosen from those conventionally used in the art, such as anionic, cationic, nonionic, amphoteric or zwitterionic surfactants or mixtures thereof, anionic, cationic, nonionic, amphoteric or zwitterionic polymers or mixtures thereof, organic or inorganic thickeners, for example the anionic, cationic, nonionic and amphoteric polymer associative thickeners, antioxidants, penetrants, sequestrants, fragrances, buffers, dispersants, conditioning agents such as, for example, modified or non-modified, volatile or non-volatile silicones, silicone rubbers, film formers, ceramides, preservatives, opacifiers, pigments, nacres, effect pigments (for example those with a low refractive index, such as fluorescent, photochromic or thermochromic pigments, and those with a higher refractive index, such as nacres or flakes), etc.

When present, the at least one adjuvant may each be present in an amount ranging from 0.01% to 20% by weight relative to the total weight of the composition.

### Organic Solvents

The composition disclosed herein, in at least one embodiment, comprises at least one organic solvent.

An organic solvent, as defined herein, is an organic substance which is liquid at a temperature of 25° C. and at atmospheric pressure (760 mmHg) and can dissolve another substance without chemically modifying it.

It should be noted that the at least one organic solvent is distinct from the compounds X and Y used in the context of the present disclosure.

The at least one organic solvent in this disclosure are chosen, for example, from aromatic alcohols such as benzyl alcohol, phenoxyethanol and phenylethyl alcohol; liquid fatty alcohols, for instance C₁₀-C₃₀ alcohols; C₁-C₆ alkanols such as ethanol, isopropanol, n-propanol, butanol, n-pentanol, 1,2-propanediol, 1,3-propanediol, 1-methoxy-2-propanol, 1-ethoxy-2-propanediol, 1,3- and 1,4-butanediol, and 1,2-hexanediol; polyols and polyol ethers possessing a free —OH function, such as 2-butoxyethanol, propylene glycol, propylene glycol monomethyl ether, diethylene glycol monomethyl and monoethyl ether, ethylene glycol monoethyl ether, ethylene glycol monobutyl ether, neopentyl glycol, isoprene glycol, glycerol, glycol, dipropylene glycol, butylene glycol and butyl diglycol; volatile silicones such as short-chain linear silicones such as hexamethyldisiloxane and octamethyltrisiloxane, cyclic silicones such as octamethylcyclotetrasiloxane, decamethylcyclopentasiloxane and dodecamethylcyclohexasiloxane, polydimethylsiloxanes with or without modification by alkyl and/or amine and/or imine and/or fluoroalkyl and/or carboxylic and/or betaine and/or quaternary ammonium functions; liquid modified polydi-methylsiloxanes; mineral, organic or vegetable oils; alkanes, such as C₅ to C₂₀ alkanes; liquid fatty acids; and liquid fatty esters, such as the benzoates or the salicylates of liquid fatty alcohols.

In at least one embodiment, the at least one organic solvent is chosen from organic oils; silicones such as volatile silicones, amino or non-amino silicone oils or rubbers, and mixtures thereof; mineral oils; vegetable oils such as olive oil, castor oil, rapeseed oil, coconut oil, wheatgerm oil, sweet almond oil, avocado oil, macadamia oil, apricot oil, safflower oil, candlenut oil, camelina oil, tamanu oil or lemon oil, and organic compounds such as alkanes, such as linear or branched C₅-C₂₀ alkanes, for instance isododecane or isohexadecane, isoparaffinic compounds such as products sold under the name Isopar E, acetone, methyl ethyl ketone, the esters of liquid C₁-C₂₀ acids and C₁-C₈ alcohols such as methyl acetate, butyl acetate, ethyl acetate and isopropyl myristate, dimethoxyethane, diethoxyethane, liquid C₁₀-C₃₀ fatty alcohols such as oleyl alcohol, esters of fatty alcohols or of liquid fatty acids such as C₁₀-C₃₀ fatty alcohol benzoates and mixtures thereof; isononyl isononanoate, isostearyl malate, pentaerythrityl tetraisostearate and tridecyl trimelate; polybutene oil; the mixture of cyclopentasiloxane (14.7% by weight)/α,ω-dihydroxypolydimethylsiloxane (85.3% by weight), or mixtures thereof.

In at least one embodiment the at least one organic solvent is chosen from silicones such as liquid polydimethylsiloxanes and modified liquid polydimethylsiloxanes, wherein their viscosity at 25° C. ranges from 0.1 cst to 1,000,000 cst, such as from 1 cst to 30,000 cst.

Non-limiting mention may be made of the following oils:
the alpha,omega-dihydroxypolydimethylsiloxane/-cyclopentadimethylsiloxane (14.7/85.3) mixture sold by Dow Corning under the name DC 1501 Fluid;
the alpha,omega-dihydroxypolydimethylsiloxane/-polydimethylsiloxane mixture sold by Dow Corning under the name DC 1503 Fluid;
the dimethicone/cyclopentadimethylsiloxane mixture sold by Dow Corning under the name DC 1411 Fluid or that sold by Bayer under the name SF1214;
the cyclopentadimethylsiloxane sold by Dow Corning under the name DC245 Fluid;
and the respective mixtures of these oils.

The at least one organic solvent of the composition may be present in an amount ranging from 0.01% to 99%, such as from 50% to 99%, by weight relative to the total weight of the composition.

The composition of the present disclosure may, in addition to the at least one organic solvent, contain water in an amount ranging from 1% to 99%, such as from 1% to 50% relative to the total weight of the composition.

The composition of the present disclosure may also be anhydrous, in other words containing less than 1% by weight of water relative to the total weight of the composition.

These compositions may take various forms, such as lotions, aerosols and foams, and may be applied in the form of a shampoo or conditioner.

In the case of aerosols, the composition of the present disclosure may contain at least one propellant. The at least one propellant may be composed of the compressed or liquefied gases which are typically employed for the preparation of aerosol compositions. Propellants according to the present disclosure include, for example, air, carbon dioxide or compressed nitrogen or a soluble gas such as dimethyl ether, halogenated (such as fluorinated) or unhalogenated hydrocarbons, and mixtures thereof.

It will also be possible to employ pocket aerosols containing at least one pocket.

According to the present disclosure, any device comprising multiple storage areas and a delivery system with at least one opening allowing the products to be mixed as they exit this device may be used for the application of the products disclosed herein.

### Dyeing Methods

The method according to the disclosure may be employed with a dyeing method which utilizes at least one oxidation dye precursor, at least one direct dye, or combinations thereof.

In one embodiment, for oxidation dyeing, the dyeing composition comprises, as an oxidation dye precursor, at least one oxidation base and optionally at least one coupler.

The oxidation bases conventionally used for oxidation dyeing include for example, para-phenylenediamines, bisphenylalkylenediamines, para-aminophenols, ortho-aminophenols and heterocyclic bases and the acid addition salts thereof.

The at least one oxidation base may be present, for example, in an amount ranging from 0.0005% to 12% by weight of the total weight of the dyeing composition, such as from 0.005% to 6% by weight.

Suitable couplers include for example, meta-phenylenediamines, meta-aminophenols, meta-diphenols and heterocyclic couplers and their addition salts with an acid.

The at least one coupler may be present, for example, in an amount ranging from 0.0001% to 10% by weight of the total weight of the dyeing composition, such as from 0.005% to 5% by weight.

As disclosed herein, the acid addition salts may be chosen from, for example, hydrochlorides, hydrobromides, sulphates, citrates, succinates, tartrates, tosylates, benzenesulphonates, lactates and acetates.

The dyeing composition may comprise at least one ionic or non-ionic direct dye. Non-limiting examples include nitrobenzene dyes, azo dyes, azomethine dyes, methine dyes, tetraazapentamethine dyes, anthraquinonoid dyes, naphthoquinone dyes, benzoquinone dyes, phenothiazine dyes, indigoid dyes, xanthene dyes, phenanthridine dyes, phthalocyanine dyes, triarylmethane-derived dyes and natural dyes, and mixtures thereof.

These direct dyes may be non-ionic, cationic or anionic. In at least one embodiment, cationic direct dyes are present in the dyeing composition.

The at least one direct dye may be present, in an amount ranging from 0.0005% to 12% by weight of the total weight of the dyeing composition, such as from 0.005% to 6% by weight.

In another embodiment, the dyeing composition may be employed in the presence of at least one oxidizing agent. This is appropriate for example, when the dyeing composition comprises at least one oxidation dye or if it is desired to operate under lightening conditions, with a dyeing composition which as dye comprises at least one direct dye.

In this case the oxidizing agent is chosen for example, from hydrogen peroxide, urea peroxide, alkali metal bromates, persalts such as perborates and persulphates, and enzymes such as two-electron or four-electron oxidoreductases and peroxidases. In at least one embodiment, hydrogen peroxide is the oxidizing agent.

The dyeing composition may further comprise all of the adjuvants conventionally employed in this art. It will be possible for example, to refer to the list given above.

These adjuvants, when present, may each be present in an amount ranging from 0.01% to 20% by weight relative to the weight of the dyeing composition.

The dyeing method comprises applying a dyeing composition to the dry or wet fibers for a time sufficient to give the desired coloration, optionally rinsing, washing with shampoo, rinsing again and then drying the fibers thus treated or allowing them to dry.

Where at least one oxidizing agent is present, it may be added to the dyeing composition at the time of use, or else it may be present in an oxidizing composition comprising it, which may be applied directly to the fibers simultaneously with or sequentially to the dyeing composition.

In one embodiment the dyeing composition is mixed, at the time of use, with a composition comprising, in a medium appropriate for dyeing, at least one oxidizing agent, wherein the oxidizing agent is present in an amount sufficient to give the desired effect. The resulting mixture is then applied to the keratin fibers.

After a period of leave-on time sufficient to give the desired coloration, commonly ranging from 3 to 50 minutes, for instance, from 5 to 30 minutes, the keratin fibers may be rinsed, optionally washed with shampoo and rinsed again, then dried or allowed to dry.

In another embodiment, the composition is applied and left to act at a temperature of from 15 to 80° C., such as from 15 to 40° C.

### Modes of Application

As was indicated previously, the composition comprising the at least one compounds X and Y can be applied before or after a dyeing treatment.

In one embodiment, a composition (A), comprising at least one compound X and at least one compound Y, and optionally comprising at least one organic solvent, is applied to wet keratin fibers, either before or after the dyeing of the keratin fibers.

In another embodiment, a composition (B) comprising at least one compound X and a composition (C) comprising at least one compound Y, the compositions (B) and (C) optionally comprising at least one organic solvent are applied, in succession and in either order, to wet keratin fibers, either before or after the dyeing of the keratin fibers. Intermediate drying may be carried out between each application, for example, with a hairdryer or tongs.

In one embodiment of the present disclosure, separate application of the at least one compounds X and Y (layered deposition) is performed in order to maintain the cosmetic or optical properties of the compound which constitutes the upper part of the deposition.

In accordance with the same methods, it can be possible to realize multiple superpositions of layers of compounds X and Y, in alternation or not, in order to produce the type of deposition desired (in terms of chemical nature, mechanical strength, thickness, appearance, feel, etc.).

If a catalyst or a peroxide is employed, it may be located in the composition (A), in which case this composition results from the mixing of at least two compositions comprising a portion of the various ingredients present, at the time of use, on the condition that the at least one compounds X and Y, and the catalyst or peroxide are not stored simultaneously in a single composition.

If a catalyst or a peroxide is employed, it may be located in the composition (B) and/or (C), or in a separate composition. In that case the order in which the compositions (B) and (C) and the composition comprising the catalyst or peroxide is applied is arbitrary.

Intermediate drying may be carried out between each application (hairdryer, tongs).

Where the composition applied to the fibers comprises at least one additional reagent, this reagent may be present in at least one of the compositions applied to the hair fibers, or in a further composition, in which case the order in which the various compositions are applied to the fibers is arbitrary.

Here as well, intermediate drying may be carried out between each application (hairdryer, tongs).

In yet another embodiment, a composition comprising at least one cosmetic adjuvant may be applied prior to the application of the composition (A) or of the compositions (B) and (C). The application of the composition comprising the at least one cosmetic adjuvant may also take place before dyeing and before the application of the at least one compounds X and Y, or else between the dyeing method and the application of the at least one compounds X and Y.

The composition comprising the at least one cosmetic adjuvant may be applied on wet or dry fibers.

Examples of cosmetic adjuvants include anti-dandruff or anti-seborrheic agents, fragrances, conventional organic and inorganic pigments, fluorescent, photochromic or thermochromic pigments, nacres or flakes, hydroxy acids, electrolytes, preservatives, silicone or non-silicone sunscreens, vitamins, provitamins such as panthenol, anionic or non-ionic polymers, proteins, protein hydrolysates, 18-methyleicosanoic acid, synthetic oils such as polyolefins, mineral oils, vegetable oils, fluoro or perfluoro oils, natural or synthetic waxes, ceramide-type compounds, esters of carboxylic acids, antioxidants, sequestrants, dispersants, conditioning agents such as, for example, cations, volatile or non-volatile silicones which have or have not been modified and are different from the at least one compounds X and Y according to the present disclosure, film formers, ceramides, preservatives, stabilizers, opacifiers, and mixtures of these various adjuvants.

In one embodiment, the composition may be applied immediately before or after the dyeing method.

In one embodiment, it is possible to wait for a number of days after dyeing before implementing the method disclosed herein, or else not to carry out dyeing until a number of days after the composition disclosed herein has been applied.

In these cases, the fibers may be washed with shampoo and rinsed or simply wetted before the composition of the present disclosure is applied.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the present disclosure are approximations, unless otherwise indicated the numerical values set forth in the specific examples are reported as precisely as possible. Any numerical value, however, inherently contain certain errors necessarily resulting from the standard deviation found in their respective testing measurements.

By way of non-limiting illustration, concrete examples of certain embodiments of the present disclosure are given below.

Unless indicated otherwise, the amounts indicated are expressed as percentages by mass.

### EXAMPLES

### Example 1

### Post-Treatment of an Oxidation Dyeing

In this example the following mixtures A′ and B′ were used:

### Mixture A′:

| | | Amounts | |
|---|---|---|---|
| Ingredient (INCI name) | CAS No. | (%) | Function |
| Bis-Trimethoxysiloxyethyl | PMN87176 | 25-45 | polymer |
| Tetramethyldisiloxyethyl | | | |
| Dimethicone (1) | | | |
| Silica Silylate | 68909-20-6 | 5-20 | filler |
| Disiloxane | 107-46-0 | 30-70 | solvent |

### Mixture B′:

| Ingredient (INCI name) | CAS No. | Amounts (%) | Function |
|---|---|---|---|
| Disiloxane | 107-46-0 | 80-99 | solvent |
| Tetra T Butyl Titanate | — | 1-20 | catalyst |

Furthermore, the following compositions were prepared:

| | |
|---|---|
| Composition (II) | |
| Composition (A) containing the bases and couplers | 25 g |
| Oxidant (composition B) | 25 g |
| Composition (III) | |
| Cyclopentadimethylsiloxane sold by Dow Corning | 83.34 g |
| under the name DC245 Fluid | |
| Mixture A′ | 15.15 g |
| Composition (IV) | |
| Mixture B′ | 1.51 g |

Composition (A), the amounts being expressed in grams:

| | |
|---|---|
| Ethylenediaminetetraacetic acid | 0.2 |
| Pure monoethanolamine | 8 |
| Erythorbic acid | 0.18 |
| Sodium metabisulphite in aqueous solution | 1.3 |
| Aqueous ammonia (concentration 20% of ammonia) | 10 |
| 2-Octyldodecanol | 10 |
| 1-Hydroxy-4-aminobenzene | 0.5 |
| 1,3-Dihydroxybenzene (resorcinol) | 0.01 |
| Ethyl alcohol, 96 degrees, denatured | 10 |
| Oleic acid | 19 |
| Triethanolamine lauryl sulphate (C12/C14 70/30) | 3 |
| in 40% aqueous solution | |
| Oleic acid diethanolamide | 12 |
| Ethoxylated (30 EO) oleocetyl alcohol | 4 |
| Ortho-aminophenol | 0.1 |
| 1-Methyl-2-hydroxy-4-aminobenzene | 0.15 |
| 1-Methyl-2-hydroxy-4-beta-hydroxyethylaminobenzene | 0.77 |
| Benzyl alcohol | 9.5 |
| Fragrance | 0.5 |
| Tetramethylhexamethylenediamine/ | 3.67 |
| 1,3-dichloropropylene polycondensate in | |
| aqueous solution | |
| Deionized water (qs) | 100 |

Composition (B) (amounts expressed in grams):

| | |
|---|---|
| Diethylenetriaminepentaacetic acid, pentasodium salt, | 0.15 |
| in 40% aqueous solution | |
| Hydrogen peroxide in solution at 50% | 15 |
| Deionized water | 80.59 |
| Sodium stannate, 6 H₂O | 0.04 |
| Glycerol | 0.5 |
| Alkyl (C13/C15 70/30, 50% linear) ether (2 EO) | 0.85 |
| carboxylic acid monoethanolamide | |
| Ethoxylated (30 EO) cetylstearyl alcohol/ | 2.85 |
| cetylstearyl alcohol mixture | |
| Tetrasodium pyrophosphate, 10 H₂O | 0.02 |

Composition (II) was applied to a lock of 2.5 g of clean and wet natural grey hair containing 90% white hair.

After a leave-on time of 15 minutes, the lock was rinsed and compositions (III) and (IV) were mixed at this time of use.

0.5 g of this mixture was applied to the lock.

After a leave-on time of one hour, the lock was dried with a hairdryer for 2 minutes.

The resulting lock was dyed copper and had a smooth and gentle feel.

The dyeing was resistant to shampooing.

### Example 2

### Post-Treatment on an Oxidation Dyeing

In this example, the following mixtures A and B were used:

### Mixture A:

| Ingredient (INCI name) | CAS No. | Amounts (%) | Function |
|---|---|---|---|
| Dimethyl Siloxane, | 68083-19-2 | 55-95 | polymer |
| Dimethylvinylsiloxy- | | | |
| terminated | | | |
| Silica Silylate | 68909-20-6 | 10-40 | filler |
| 1,3-Diethenyl-1,1,3,3- | 68478-92-2 | trace | catalyst |
| Tetramethyldisiloxane | | | |
| complexes | | | |
| Tetramethyldivinyldisiloxane | 2627-95-4 | 0.1-1 | polymer |

### Mixture B

| Ingredient (INCI name) | CAS No. | Amounts (%) | Function |
|---|---|---|---|
| Dimethyl Siloxane, | 68083-19-2 | 55-95 | polymer |
| Dimethylvinylsiloxy- | | | |
| terminated | | | |
| Silica Silylate | 68909-20-6 | 10-40 | filler |
| Dimethyl, Methyl-hydrogen | 68037-59-2 | 1-10 | polymer |
| Siloxane, trimethylsiloxy- | | | |
| terminated | | | |

The following compositions were prepared:

| | |
|---|---|
| Composition (II) | |
| Composition (A) containing the bases and couplers | 25 g |
| Oxidant (composition B) | 25 g |
| Composition (III) | |
| Cyclopentadimethylsiloxane sold by Dow Corning | 90 g |
| under the name DC245 Fluid | |
| Mixture A | 10 g |
| Composition (IV) | |
| Cyclopentadimethylsiloxane sold by Dow Corning | 90 g |
| under the name DC245 Fluid | |
| Mixture B | 10 g |

Composition (II) was applied to a lock of 2.5 g of clean and wet natural grey hair containing 90% white hair.

After a leave-on time of 15 minutes, the lock was rinsed and compositions (III) and (IV) were mixed at this time of use.

0.5 g of this mixture was applied to the lock.

After a leave-on time of one hour, the lock was dried with a hairdryer for 2 minutes.

The resulting lock was dyed copper and had a smooth and gentle feel.

The dyeing was resistant to shampooing.

### Example 3

### Post-Treatment on a Direct Dyeing

In this example the mixtures A′ and B′ of Example 1 were used.

The following compositions were prepared:

Composition 1

| | in g |
|---|---|
| Cyclopentadimethylsiloxane sold by Dow Corning | 87.78 |
| under the name DC245 Fluid | |
| Mixture A′ | 11.11 |

Composition 2

| | in g |
|---|---|
| Mixture B′ | 1.11 |

3 g of Color Pulse® pulse red direct dyeing composition were applied to two locks of 1 g of clean and wet, permed grey hair containing 90% white hair.

After a leave-on time of 15 minutes the locks were rinsed and then wrung.

Compositions 1 and 2 were mixed at the time of use.

0.5 g of this mixture was applied to one of the dyed locks.

After a leave-on time of one hour, the lock was dried with a hairdryer for 2 minutes.

After 15 shampooings, the color of the lock which had been dyed and then treated in accordance with the present disclosure was more vivid than the lock dyed identically with Color Pulse® pulse red and shampooed 15 times in accordance with the same procedure.

### Example 4

### Pre-Treatment on a Direct Dyeing

For this example the mixtures A′ and B′ of Example 1 were used.

The following compositions were produced:

Composition 1

| | in g |
|---|---|
| Cyclopentadimethylsiloxane sold by Dow Corning | 87.78 |
| under the name DC245 Fluid | |
| Mixture A′ | 11.11 |

Composition 2

| | in g |
|---|---|
| Mixture B′ | 1.11 |

The compositions 1 and 2 were mixed at the time of use.

0.25 g of this mixture was applied, by brush, to a wet 1 g lock of permed white hair.

After a leave-on time of one hour, the lock was dried under a hood for 30 minutes and then combed.

The Maji Contrast® copper red direct dye was applied to this lock recorded as M.

The dye was also applied to a permed white control lock recorded as T.

It was observed that the lock M which has received the composition containing reactive silicones was more uniform in color over its length than the simply dyed control lock T.

The lock M was said to have a better homogeneity than the control lock T.

### Example 5

### Post-Treatment on a Direct Dyeing

In this example the mixtures A and B of Example 2 were used.

The following compositions were prepared:

Composition 1

| | % by weight |
|---|---|
| Cyclopentadimethylsiloxane sold by Dow Corning | 92 |
| under the name DC245 Fluid | |
| Mixture A | 8 |

Composition 2

| | % by weight |
|---|---|
| Cyclopentadimethylsiloxane sold by Dow Corning | 92 |
| under the name DC245 Fluid | |
| Mixture B | 8 |

3 g of Color Pulse® pulse red direct dyeing composition were applied to two locks of 1 g of clean and wet, permed grey hair containing 90% white hair.

After a leave-on time of 15 minutes the locks were rinsed and then wrung.

Compositions 1 and 2 were mixed at the time of use.

0.5 g of this mixture was applied to one of the dyed locks.

After a leave-on time of one hour, the lock was dried with a hairdryer for 2 minutes.

After 15 shampooings, the color of the lock which had been dyed and then treated in accordance with the present disclosure was more vivid than the lock dyed identically with Color Pulse® pulse red and shampooed 15 times in accordance with the same procedure.

### Example 6

### Pre-Treatment on a Direct Dyeing

In this example the mixtures A and B of Example 2 were used.

The following compositions were prepared:

Composition 1

| | in g |
|---|---|
| Cyclopentadimethylsiloxane sold by Dow Corning | 92 |
| under the name DC245 Fluid | |
| Mixture A | 8 |

Composition 2

| | % by weight |
|---|---|
| Cyclopentadimethylsiloxane sold by Dow Corning | 92 |
| under the name DC245 Fluid | |
| Mixture B | 8 |

The compositions 1 and 2 were mixed at this time of use.

0.25 g of this mixture was applied, by brush, to a wet 1 g lock of permed white hair.

After a leave-on time of one hour, the lock was dried under a hood for 30 minutes and then combed.

The Maji Contrast® copper red dye was applied to this lock recorded as M.

The dye was also applied to a permed white control lock recorded as T.

It was observed that the lock M which had received the composition containing reactive silicones was more uniform in color over its length than the simply dyed control lock T.

The lock M was found to have a better homogeneity than the control lock T.

What is claimed is:

1. A method of treating human keratin fibers, either before or after dyeing said fibers, which comprises applying to said fibers, either before or after said dyeing step, at least one composition comprising at least one compound X and at least one compound Y, at least one of the compounds, X and Y, being a silicone compound; wherein, when X and Y are placed in contact with each other they react together via
a hydrosilylation reaction,
a condensation reaction, or
by a crosslinking reaction in the presence of a peroxide.

2. The method according to claim 1, further comprising applying to said fibers at least one catalyst, wherein the at least one catalyst is applied simultaneously with or separately from the at least one composition.

3. The method according to claim 1, wherein when the at least one compound X and at least one compound Y are placed in contact with each other they react together via hydrosilylation.

4. The method according to claim 3, wherein the at least one compound X is chosen from silicone compounds comprising at least two unsaturated aliphatic groups.

5. The method according to claim 4, wherein the at least one compound X is a polyorganosiloxane comprising a main silicone chain whose unsaturated aliphatic groups are pendant to the main chain, or are situated at the ends of the main chain of the compound.

6. The method according to claim 3, wherein the at least one compound X is chosen from polyorganosiloxanes comprising at least two unsaturated aliphatic groups each bonded to a silicon atom.

7. The method according to claim 3, wherein the at least one compound X is chosen from polyorganosiloxanes comprising siloxane units of formula (I):
$${R}_{m} {R}^{′} {SiO}_{\frac{( 3 - m )}{2}} \qquad ( I )$$
wherein:
R is chosen from monovalent linear or cyclic hydrocarbon groups containing 1 to 30 carbon atoms,
m is 1 or 2, and
R′ is chosen from unsaturated aliphatic hydrocarbon groups containing 2 to 10 carbon atoms or an unsaturated cyclic hydrocarbon group containing 5 to 8 carbon atoms.

8. The method according to claim 7, wherein R′ is chosen from a vinyl group and —R″—CH═CHR′″, wherein R″ is a divalent aliphatic hydrocarbon chain containing 1 to 8 carbon atoms which is bonded to the silicon atom, and R′″ is chosen from hydrogen and C₁-C₄ alkyl radicals.

9. The method according to claim 9, wherein R′″ is hydrogen.

10. The method according to claim 7, wherein R is chosen from C₁-C₁₀ alkyl radicals and a phenyl group, and R′ is a vinyl group.

11. The method according to claim 3, wherein the polyorganosiloxanes further comprise units of formula (II):
$${R}_{n} {SiO}_{\frac{( 4 - n )}{2}} \qquad ( II )$$
wherein R is a monovalent linear or cyclic hydrocarbon group containing 1 to 30 carbon atoms and n is 1, 2 or 3.

12. The method according to claim 1, wherein the at least one compound X is chosen from:
organic oligomers and polymers; and
hybrid organic/silicone oligomers and polymers;
wherein said oligomers and polymers carry at least two reactive unsaturated aliphatic groups.

13. The method according to claim 1, wherein the at least one compound Y is chosen from organosiloxanes comprising at least two free Si—H groups.

14. The method according to claim 13, wherein the at least one compound Y is chosen from organosiloxanes comprising at least one alkylhydrogenosiloxane unit of formula (III):
$${R}_{p} {HSiO}_{\frac{( 3 - p )}{2}} \qquad ( III )$$
wherein:
R is a monovalent linear or cyclic hydrocarbon group containing 1 to 30 carbon atoms, or a phenyl group, and p is 1 or 2.

15. The method according to claim 14, wherein R is chosen from C₁-C₁₀ alkyl groups.

16. The method according to claim 15, wherein R is a methyl group.

17. The method according to claim 13, wherein the at least one compound Y is chosen from organosiloxanes comprising at least two alkylhydrogenosiloxane units of formula —(H₃C)(H)Si—O— and optionally comprise —(H₃C)₂SiO— units.

18. The method according to claim 2, wherein the at least one catalyst is chosen from catalysts based on platinum and based on tin, and is present in the at least one composition comprising X and Y, or in a separate composition.

19. The method according to claim 18, wherein the at least one catalyst is present in an amount ranging from 0.0001% to 20% by weight relative to the total weight of the composition.

20. The method according to claim 1, wherein the at least one compound X is chosen from polydimethylsiloxanes having terminal vinyl groups, and the at least one compound Y is a methylhydrogenosiloxane.

21. The method according to claim 1, wherein when the at least one compound X and the at least one compound Y are placed in contact with each other, react together via condensation.

22. The method according to claim 21, wherein at least one of the compounds X and Y, which may be identical or different, are silicone compounds whose main chain comprises at least two alkoxysilane groups and/or at least two silanol groups (Si—OH), which are side groups and/or chain-end groups.

23. The method according to claim 21, wherein at least one of the compounds X and Y, which may be identical or different, predominantly comprise units of formula (IV):
R⁹ₛSiO_{(4-s)/2}, (IV)
wherein each R⁹ is independently chosen from radicals chosen from C₁-C₆ alkyl groups, phenyl and fluoroalkyl groups, and s is 0, 1, 2 or 3.

24. The method according to claim 23, wherein at least one of the compounds X and Y, which may be identical or different, comprise units of formula (V):
(R⁹₂SiO₂)_{f}— (V)
wherein R⁹ is independently chosen from radicals chosen from C₁-C₆ alkyl groups, phenyl and fluoroalkyl groups,
f is such that the polymer has a viscosity at 25° C. ranging from 0.5 to 3000 Pa.s, and/or f is a number ranging from 2 to 5000.

25. The method according to claim 21, wherein the at least one compounds X and Y are chosen from polyorganosiloxanes comprising at least two terminal trialkoxysilane groups per polymer molecule, wherein said groups are chosen from those of formula (VI):
-ZSiR¹ₓ(OR)₃₋ₓ, (VI)
wherein
R is independently chosen from methyl, ethyl, n-propyl, isopropyl, n-butyl, sec-butyl and isobutyl groups,
R¹ is a methyl or ethyl group,
x is 0 or 1, and
Z is chosen from:
divalent hydrocarbon groups containing no ethylenic unsaturation and containing 1 to 18 carbon atoms, and
the combinations of divalent hydrocarbon radicals and of siloxane segments of formula (IX): 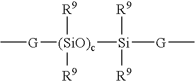
wherein R⁹ is independently chosen from radicals chosen from C₁-C₆ alkyl groups, phenyl and fluoroalkyl groups, G is chosen from divalent hydrocarbon radicals containing no ethylenic unsaturation and containing 1 to 18 carbon atoms, and c is an integer of from 1 to 6.

26. The method according to claim 21, wherein the at least one compounds X and Y are chosen from polyorganosiloxanes comprising polymers of formula (VII): 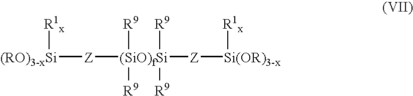
wherein
R is chosen from methyl, ethyl, n-propyl, isopropyl, n-butyl, sec-butyl and isobutyl-groups;
R¹ is a methyl or ethyl group;
x is 0 or 1; and
Z is chosen from divalent hydrocarbon groups containing no ethylenic unsaturation and containing 1 to 18 carbon atoms, wherein the combinations of divalent hydrocarbon radicals and siloxane segments of formula: 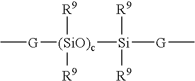
wherein:
R⁹ is a radical chosen from alkyl groups containing 1 to 6 carbon atoms, phenyl, and fluoroalkyl groups;
G is chosen from divalent hydrocarbon radical containing no ethylenic unsaturation and containing 1 to 18 carbon atoms; and
c is an integer from 1 to 6.

27. The method according to claim 21, wherein the at least one compound X is chosen from organic oligomers and polymers, and hybrid organic/silicone oligomers and polymers, wherein the polymers and oligomers comprise at least two alkoxysilane groups, and the at least one compound Y is chosen from polyorganosiloxanes.

28. The method according to claim 21, wherein at least one of the compositions further comprises at least one catalyst based on titanium.

29. The method according to claim 28, wherein the at least one catalyst is present in an amount ranging from 0.0001% to 20% by weight relative to the total weight of the composition.

30. The method according to any one of claim 21, wherein the at least one compound X and the at least one compound Y are chosen from a mixture of polydimethylsiloxanes having methoxysilane groups.

31. The method according to claim 1, wherein when the at least one compound X and at least one compound Y are placed in contact with each other, they react together via crosslinking in the presence of peroxide.

32. The method according to claim 1, wherein the at least one composition further comprises at least one filler.

33. The method according to claim 1, wherein the at least one compound X has a weight-average molecular mass (Mw) ranging from 150 to 1,000,000.

34. The method according to claim 33, wherein the at least one compound X has a weight-average molecular mass (Mw) ranging from 200 to 250,000.

35. The method according to claim 1, wherein the at least one compound Y has a weight-average molecular mass (Mw) ranging from 200 to 1,000,000.

36. The method according to claim 35, wherein the at least one compound Y has a weight-average molecular mass (Mw) ranging from 500 to 250,000.

37. The method according to claim 1, wherein the at least one compound X is present in an amount ranging from 0.5% to 95% by weight relative to the total weight of the composition.

38. The method according to claim 1, wherein the at least one compound Y is present in an amount ranging from 0.05% to 95% by weight relative to the total weight of the composition.

39. The method according to claim 1, wherein the at least one compound X and the at least one compound Y are present in the at least one composition in an X/Y molar ratio ranging from 0.05 to 20.

40. The method according to claim 39, wherein the at least one compound X and the at least one compound Y are present in the at least one composition in an X/Y molar ratio ranging from 0.1 to 10.

41. The method according to claim 1, wherein, before or after said dyeing step, a composition (A) comprising at least one compound X, at least one compound Y, optionally at least one catalyst, optionally at least one peroxide and optionally at least one organic solvent is applied, wherein said composition is obtained by mixing two or more compositions at the time of use.

42. The method according to claim 1, wherein, before or after said dyeing step, a composition (B) comprising at least one compound X and a composition (C) comprising at least one compound Y are applied in succession in any order, wherein the compositions (B) and (C) optionally comprise at least one organic solvent.

43. The method according to claim 41, wherein, prior to the application of the composition (A) a composition comprising at least one cosmetic adjuvant is applied.

44. The method according to claim 42, wherein, prior to the application of the compositions (B) and (C), a composition comprising at least one cosmetic adjuvant is applied.

45. The method according to claim 1, wherein the dyeing step comprises direct dyeing comprising applying to the keratin fibers at least one direct dye.

46. The method according to claim 45, wherein the at least one direct dye is a cationic direct dye.

47. The method according to claim 1, wherein the dyeing step comprises applying to the keratin fibers at least one oxidation dye in combination with at least one oxidation base.
